(19) United States
(12) Patent Application Publication
(10) Pub. No.: US 2010/0176674 A1
(43) Pub. Date: Jul. 15, 2010

(54) Gear Trains Employing Magnetic Coupling

(76) Inventor: Richard Freeman Post, Walnut Creek, CA (US)

Correspondence Address: LLNS / John P. Wooldridge;John H. Lee, Assistant Laboratory Counsel, L-703, P.O Box 808, Livermore, CA, 94551, US

(21) Appl. No.: 12/687,585

(22) Filed: Jan. 14, 2010

Related U.S. Application Data
(60) Provisional application No. 61/144,673, filed on Jan. 14, 2009.

(51) Int. Cl. H02K 49/10

(52) U.S. Cl. 310/103

(57) ABSTRACT

A first movable element includes a first Halbach array permanent magnet array. A second movable element placed in operable proximity to said first Halbach array includes a second Halbach array permanent magnet array. The first Halbach array is configured to transmit torque upon movement to the second movable element by magnetic force, wherein the torque is transferred with no physical contact occurring between the first movable element and the second movable element.

This application claims priority to U.S. Provisional No. 61/144,673, titled “Gear Trains Employing Magnetic Coupling,” filed Jan. 14, 2009.

The United States Government has rights in this invention pursuant to Contract No. DE-AC52-07NA27344 between the United States Department of Energy and Lawrence Livermore National Security, LLC.

### BACKGROUND OF THE INVENTION

1. Field of the Invention

The present invention relates to gear trains, and more specifically, it relates to gear trains employing magnetic coupling.

2. Description of Related Art

Gears enable the operation of many mechanical devices. Conventional gears have teeth that mesh with the teeth of other gears rotate one another. Substantial frictional forces are produced between meshing teeth which leads to wear and breakage.

Prior-art magnetic gear systems have attempted to overcome the problems inherein in conventional gears, however, they have an intrinsic deficiencies. For example, they exhibit substantial periodic variations of the inter-gear torque that they produce. These periodic variations arise from the marked changes in the inter-gear geometry that occur during rotation.

### SUMMARY OF THE INVENTION

It is an object of the present invention to ameliorated the periodic variations of the inter-gear torque produce by magnetic gears known in the art.

These and other objects will be apparent based on the disclosure herein.

The invention provides gear trains that comprise a first movable element that includes a first Halbach array permanent magnet array; and a second movable element that includes a second Halbach array permanent magnet array, wherein the first Halbach array is configured to transmit torque upon movement of the first movable element to the second movable element by magnetic force, wherein the torque is transferred with no physical contact occurring between the first movable element and the second movable element.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a magnet array and field lines for an opposing-force Halbach array orientation.

FIG. 2 shows a variation of attractive/repulsive force between two Halbach arrays as a function of lateral displacement of one array with respect to the other.

FIG. 3 shows stiffness for vertical displacement of Halbach arrays with respect to each other plotted as a function of lateral displacement.

FIG. 4 shows a “Potential well” for azimuthal displacement of Halbach arrays with respect to each other.

FIG. 5 shows a schematic drawing of a ring and planetary gear assembly.

FIG. 6 shows a plot of maximum azimuthal force as a function of gap between the surface of the planetary gears and the surface of the inner gear of FIG. 5.

FIG. 7 shows the gap between inner-gear and planetary gear surfaces plotted as a function of the arc angle of the inner gear, as measured from the point of closest approach.

FIG. 8 shows the maximum relative force between a planetary gear and the inner gear plotted as a function of the arc angle (around the inner gear) between the point of observation and the position of minimum gap between the gear surfaces.

FIG. 9 shows a schematic drawing of a ring “gear” plus a single off-center “gear”.

FIG. 10 shows the maximum azimuthal force per square meter as a function of the azimuthal angle (measured around the inner gear) of FIG. 9.

FIG. 11 shows a schematic drawing of a circular Halbach array interacting with an iron rail that has cogs.

FIG. 12 illustrates a configuration for the case of the primary gear having twice the radius of the secondary gear.

FIG. 13 shows the magnets of the arrays aligned helically so that a displacement (which could be of order one-quarter wavelength of the array) occurs in moving from one end of the drum to the other end.

FIG. 14 is a schematic of a layered Halbach array, showing an M=4 base array with an M=4 third-harmonic array on top of it.

FIG. 15A is a waveform of an M=4 array at working surface.

FIG. 15B is a waveform of a layered Halbach array at the same working surface of FIG. 15A but with a thin fifth-harmonic shimming Halbach array on top of main Halbach array.

FIG. 16 shows a waveform for a two-layer Halbach array with a third-harmonic top layer having a thickness equal to 1/9 of the thickness of the main array.

FIG. 17 shows a waveform for a three-layer Halbach array (fundamental, plus 3^{rd} and 5^{th} harmonic arrays).

FIG. 18 is a schematic of a magnet orientation of a top (fifth-harmonic) three-layer Halbach array generator with side-by-side arrays phase-shifted by one-quarter wavelength of the fundamental array wavelength, i.e, 5/4 wavelengths of the fifth-harmonic arrays shown.

FIG. 19 is the output waveform generated by a dual three-layer Halbach array

FIG. 20 is the generated output waveform resulting from full-wave rectification of the generator output waveform shown in FIG. 19 (with removal of dc component by use of a coupling capacitor).

### DETAILED DESCRIPTION OF THE INVENTION

This disclosure includes four (4) sections. Based on the disclosure herein, those skilled in the art will understand that the concepts taught in each section are applicable to the other sections. For example, the layered Halbach arrays concept of Section IV can be applied to the gear trains of sections I-III. Where the disclosure refers to “the invention” or similar terms, it should be understood to be a description of an exemplary embodiment of the invention as well as methods of using such embodiments.

### Section I

Embodiments of the invention relate to a means for constructing gear trains that employ the magnetic fields of circular Halbach arrays to perform a function similar to that of the cogs on conventional gears. There being no physical contact between the gears, the problems of lubrication and wear suffered by conventional gears are not present. Applications include high-power gear trains for wind turbines, smaller gear trains for a variety of uses, power-pickup and/or traction for train systems, and drive gear trains for use in propeller-powered ships. Since the inter-gear forces are transmitted solely by magnetic forces, the gear forces can be transmitted between two different environments, e.g., vacuum and atmospheric pressure or between regions one of which might involve liquids.

### I. Introduction to Section I

Countless commercial devices employ gear trains to couple rotational mechanical energy between parts of the system. Examples include the very large gear trains used in wind-power turbines to couple the low-RPM rotational energy of the wind turbine to a generator that operates at a higher RPM. These gear trains require constant lubrication, are subject to mechanical failure owing to the high mechanical stresses involved, and must be carefully maintained. This disclosure describes exemplary embodiments of a new form of gear train, one in which the “gears” employ permanent magnet arrays (Halbach arrays) so that torques are transmitted from “gear” to “gear” by magnetic forces, with no physical contact occurring between them. This concept then allows the design of gear trains for which the problems of lubrication and physical wear of the gears associated with conventional gear trains are no longer present.

### II. Operating Principles of the Concept of Section I

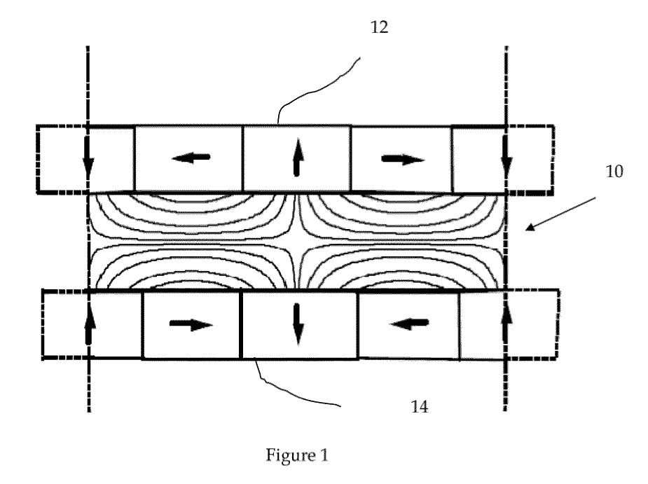

Embodiments of the new system employ the magnetic forces exerted between Halbach arrays located on the surfaces of cylinders to couple the torques between two rotating shafts. The key point here is that in translating one Halbach array with respect to another, the forces between the arrays vary in a periodic manner. With respect to the forces that are perpendicular to the faces of the two arrays, the forces will be attractive when the perpendicular components of the two fields are additive, and repulsive when these components are opposite in direction. FIG. 1 shows the field lines 10 between two planar Halbach arrays 12, 14 in the latter (repulsive force) case.

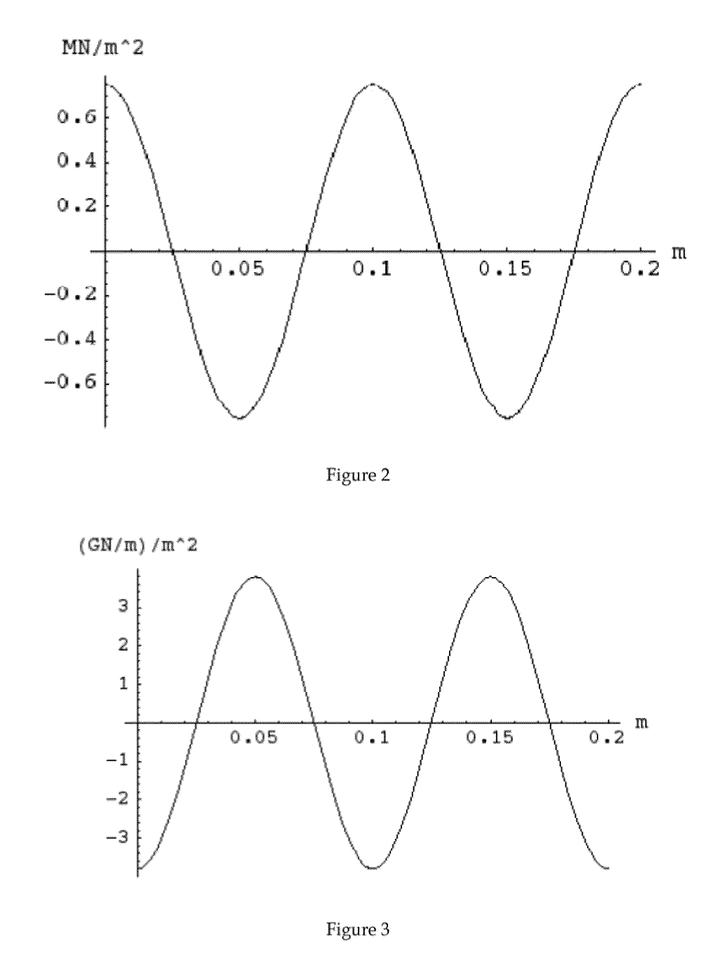

A plot of the variation of vertical (y direction) force vs displacement in the horizontal (x) direction has the sinusoidal form shown in FIG. 2, with positive values corresponding to attractive force and vice versa. The figure shows the calculated force per square meter between two planar Halbach arrays each of which is made up of blocks of Neodymium-Iron-Boron magnets arranged in the M=4 configuration shown in FIG. 1. The wavelength of the arrays is 10 centimeters and the gap between them is 2.0 mm. Note that the forces are quite large, with a total swing (positive peak to negative peak) of about 1.5 MegaNewtons per square meter of array.

The rate of variation of force with vertical displacement of the upper array corresponds to the “stiffness” of the system, with positive stiffness being associated with repulsive forces and negative stiffness being associated with attractive forces. FIG. 3 is a plot of the calculated stiffness function for the same case as that shown in FIG. 2. Note again the very large peak values of the stiffness per square meter of array—about 4 GigaNewtons/meter per square meter of array.

The above calculations were concerned with the attractive/repulsive forces between the arrays and the associated stiffness. In one of the present “gear” applications of Halbach arrays, the concern is with the forces associated with relative displacements that are parallel to the faces. In 2-D periodic arrays it can be shown that the stiffness for a displacement parallel to the faces of the arrays is exactly equal in magnitude, but opposite in sign, to the stiffness for a displacement perpendicular to the faces. In arrays located on the surface of a cylinder, such as present exemplary embodiments considered herein, where the wavelength of the array is smaller than the radius of the cylinder, this same relationship between the stiffness for displacements that are parallel and those that are perpendicular to the face of the array are preserved to a close approximation.

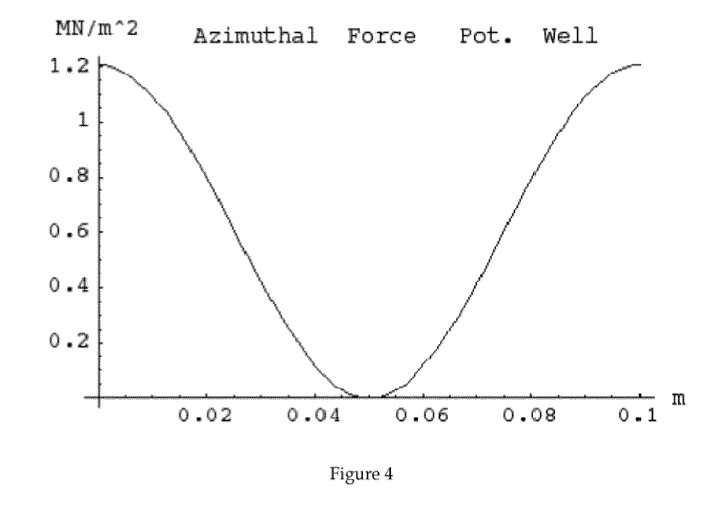

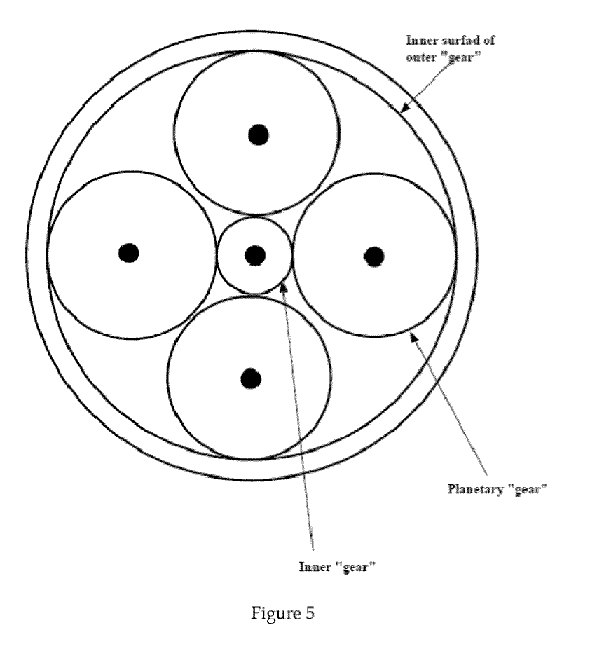

As a consequence of the above-mentioned near equality between the absolute value of stiffness for radial and azimuthal displacements, it follows that the azimuthally directed restoring force for azimuthal displacements from the equilibrium position (the position corresponding to the maximum attractive force between the arrays) can be represented by a “potential well,” calculated by displacing the zero point of the force plot in FIG. 2 so that the zero now occurs at the most negative part of the plot. That is to say, the force required to displace the arrays in the azimuthal direction from the equilibrium position takes the form shown in FIG. 4.

From this plot it can be deduced that the “mechanical strength” of this Halbach array “gear” is about 1.2 MegaNewtons per square meter of array. This force is the one herein used (reduced by a “safety-margin factor”) to calculate the power-handling ability of exemplary embodiments of the Halbach array gear train. The number of “square meters” between the arrays that is effective in producing the “gear” force will be determined (to a good approximation) by summing up the contribution of each differential strip of area of the expanding gap between the circular gears by the force per unit area associated with that gap, as determined from the magnetic fields calculated from Halbach's theory of his arrays.

### III. Example I

### “Ring and Planetary Gear” System

The example given in this section is one that can be employed, e.g., in a wind turbine. In such a case the gear box would be used to increase the rotation speed of the wind turbine (of order 20 RPM in the example) up to a higher speed in order to drive a generator. Depending on the parameters of the generator, a second Halbach array gear box might be used in series to achieve the finally desired rotation speed. However, because of the increased input rotational speeds involved, the second gear box would expected to be substantially smaller in size than the first gear box.

FIG. 5 is a schematic drawing of the Example I gear box. This embodiment includes an outer gear 20 having an inner surface on which Halbach arrays are located. Planetary gears 22-25 are within the ring formed by outer gear 20. An inner gear 28 is centrally located. Each of the “gears” shown is assumed to have an elongated Halbach array on its cylindrical working surface. The wavelength in the azimuthal direction of this array is small compared to the radius of the gear, and the thickness of the magnets of this array in the radial direction, of order a quarter-wavelength, is thus very small compared to the gear radius. At each end of every cylindrical “gear” there would be located conventional mechanical bearings allowing free rotation and maintaining the inter-gear alignment. The embodiment of FIG. 5 can operate in several ways. For example, the outer gear 28 can be rotated, which will cause the planetary gears 22-25 to rotate, which will cause the inner gear 28 to rotate. This embodiment can also be driven by rotation of inner gear 28, which will drive the planetary gears, which will drive the outer gear.

Using a computer code developed to represent a Halbach-array gear train, examples of ring and planetary gear boxes were calculated. The figures to follow are plots representing results from this code.

Example I is of a gear train with a step-up gear ratio of about 1:6, so that when the ring gear rotates at a speed of 20 RPM the central gear rotates at 120 RPM. The power transferred is 1.0 Megawatts. The radius of the ring gear is 1.6 meters, the radius of the planetary gears is 0.66 meters, and the radius of the inner gear is 0.275 meters, and the axial length of all the gears is 1.5 meters. The operating “safety-factor” of the gear train is 0.8. That is, the inter-gear force at the operating power is 80 percent of its maximum value as determined by the strength of the magnetic field and the length of the Halbach arrays on the surface of the “gears.”

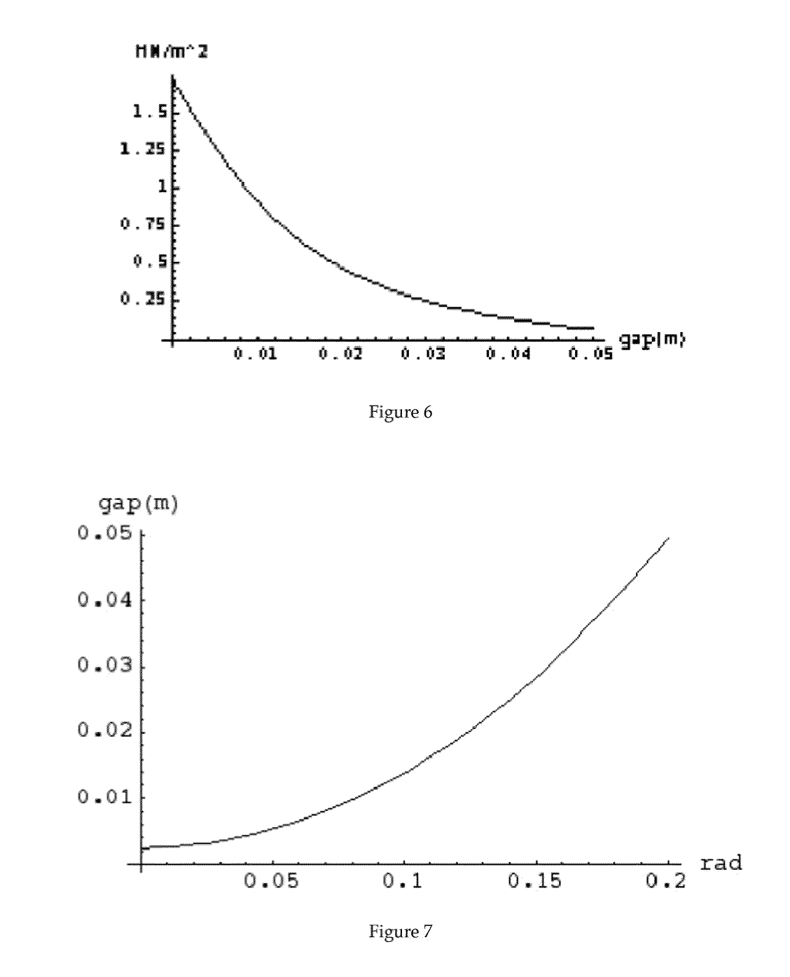

The Halbach arrays in this example employing Neodymium-Iron-Boron magnets with a remanent field of 1.4 Tesla, have a wavelength of 0.1 m. and have a thickness of 30 mm. The calculated “maximum value” of the force per square meter for this gear train is the peak value of the force shown in FIG. 2, corresponding to the force associated with the minimum gap between the gear surfaces, here taken to be 2.5 mm. This maximum azimuthal force decreases as the gap between the gears increases as a result of the curvature of the surface of the gears. In the calculations this decrease in force is taken into account by integrating the azimuthal inter-gear force over an arc-length of the smaller of the gears. The dependence of the force between each of the planetary gears and the central gear as a function of the gap between them is shown in the plot in FIG. 6.

FIG. 7 shows the variation of the gap between the planetary gears and the inner gear as a function of the half-arc length (measured from the location of closest approach) in radians.

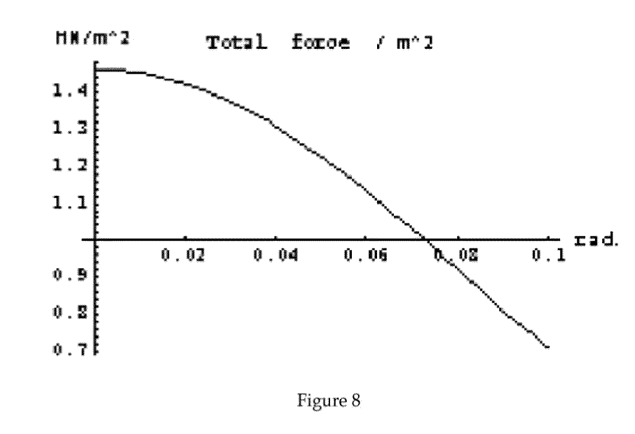

Using the data presented in FIGS. 6 and 7, the total force per square meter of area as a function of the arc angle on the inner gear is plotted in FIG. 8

As noted earlier the power transmitted in this Example I case is 1.0 Megawatts. In the example, the use of four planetary gears engaging with a central gear increases the maximum torque that can be exerted on that gear, thus increasing the power-handling ability of the gear train by a factor of four, as compared to the case of a single planetary gear.

### IV. Example II

### Ring gear and off-center gear; eddy-current brake

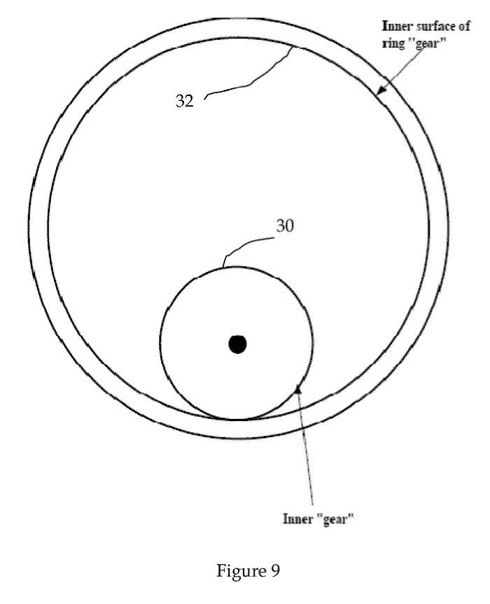

This example illustrates a gear train where the curvature of both gears has the same sign so that the effective area of interaction between the two gears is increased relative to that which would apply if the two curvatures were of opposite sign, as is the case for the planetary gears and the central gear of the previous example. It is also represents a configuration that would permit the use of several off-center gears, in applications such as a wind turbine where the ring gear, driven by the wind turbine, would drive several smaller generators. FIG. 9 is a schematic drawing of the configuration with one off-center gear 30 driven by the ring gear 32. The gear ratio in this case is 1:5, i.e., the rotation speed of the inner gear is five times that of the ring gear.

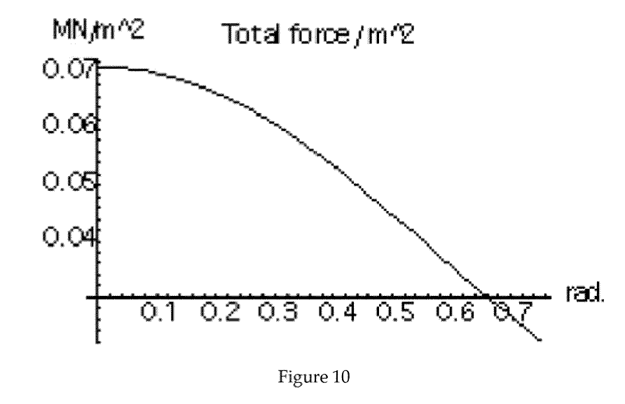

FIG. 10 shows the calculated maximum azimuthal force per unit area as a function of the arc angle relative to the position of minimum gap between the two gears and the point of observation. In this example the radius of the ring gear is 1.0 meters and that of the off-center gear is 0.2 meters. The axial length of both gears is 1.5 meters. When the ring gear rotates at a speed of 20 RPM the power transferred is 210 kW.

In some applications it might be important to introduce, on demand, a braking force that would prevent over-speeding of the system, as could be the case in a wind-turbine application. In the Halbach-array-based gear train this braking action could be accomplished by mechanically inserting a conducting metallic (such as copper or aluminum) sheet in the gap between the gears. A calculation was made for the case of Example II from which it was found that the drag power at the operating speed was 1.8 Megawatts, i.e., it was much larger than the operating power level. The drag force that this represents would thus be sufficient to brake the system down to a speed that would be small compared to the normal operating speed.

### V. Scaling of the Transmitted Power with Size and Rotation Speed

The fact that the inter-gear force is independent of the rotation speed of the gears means that the power transmitted by a Halbach-array gear train scales up directly with the rotation speed of the gears. Thus at typical speeds of 1000 RPM or above, high power levels can be transmitted using relatively small gear boxes.

For example, consider Example III, one in which the ring and inner gears system of Example II, are scaled down in size to a ring gear radius of 0.25 meters and a central gear radius of 0.05 meters. Driving the central gear at a speed of 7500 RPM, the ring gear would rotate at a speed of 1600 RPM. At an operating safety factor of 0.8 the power throughput of this transmission would be about 300 kW (400 hp). Even smaller systems could be employed as gear boxes to be used with electric motors for industrial or other applications.

### VI. Using Halbach-Array-Based “Gears” for Power Transmission Through a Dielectric Barrier

The fact that the inter-gear forces in the Halbach-array-based gear train are transmitted magnetically means that it is possible to insert a barrier made of non-conducting material between two such gears without interfering with the power transmitted between them. Thus it would be possible, for example, to couple the energy from a rotating system outside (or inside) an evacuated chamber without appreciable losses. If required, the rotation speeds of either the system inside the chamber or that outside the chamber could be increased or decreased in the manner described in the preceding examples. Again, by using several “gears” outside (or inside) the chamber the transmitted power could be increased substantially.

### VII. Some Applications of the Concept to Transit Systems

The basic concept of using the periodic magnetic field of Halbach arrays on the surface of a cylinder to transmit torques, could have several other applications in addition to those of the “gear boxes” described in the previous sections. One such application would be its use in a magnetic levitation train car to provide electrical power for the “housekeeping” energy needs of the car, e.g., lighting, heating, and air conditioning. For example, in the Inductrack maglev system, levitation is accomplished, utilizing planar Halbach arrays mounted on the car, when the car is in motion over a “track” composed of a ladder-like array of shorted electrical conductors. Mounting a circular Halbach array on the train car with its axis of rotation perpendicular to the fore-and-aft direction of the car, and with its lower surface in close proximity to the track, would result in a torque exerted on the array that would cause it to rotate. This torque, if now coupled to an electrical generator, could be used to provide “housekeeping” power, together with power to recharge a back-up battery system that would carry the load when the train car was stopped at a station.

Another possible application to transit systems would be use of Halbach-array-based “gears” to propel a vehicle. In the Swiss Alps there are many electrically powered train cars that employ large toothed gears meshing with a linear array of cogs on the track to propel the car up grades that are too steep for ordinary driven-wheel train cars. These mechanical cog wheels can be replaced by circular Halbach-arrays. On an Inductrack-based maglev system these Halbach arrays could then either operate by interacting with the track, in the manner of a linear induction motor with its force coming from the “slip” velocity between the relative motion of the circular Halbach array and the track, or it could, as in the Swiss cog trains, operate against a cogged set of iron poles embedded between the left and right Inductrack tracks. However, in this latter case there would no longer be the problem of mechanical wear and lubrication associated with mechanically based cog trains.

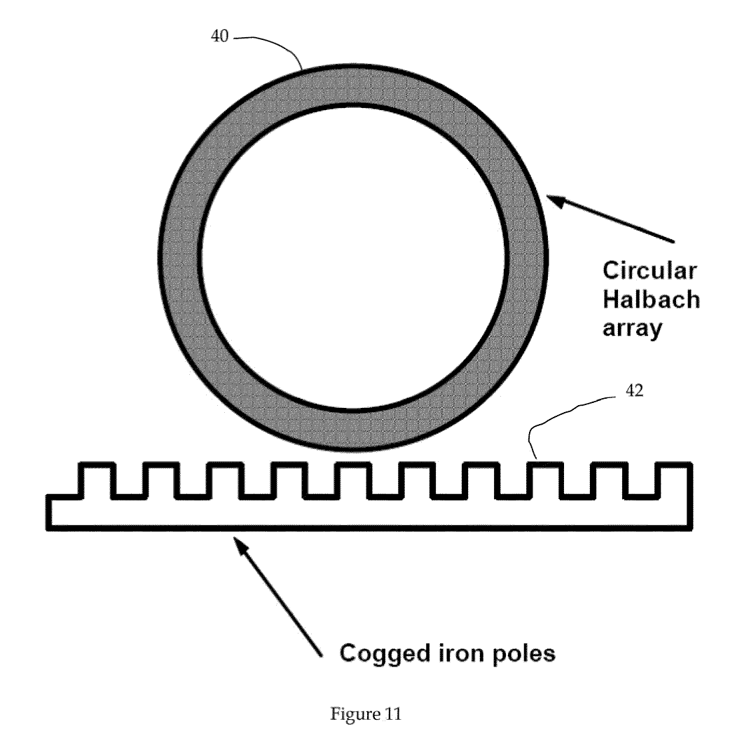

The “magnetic-cog” propulsion concept is shown schematically in FIG. 11. Ring 40 includes a circular Halbach array. Cogged iron poles 42 are employed as a track in this embodiment. To generate the necessary propulsion force more than one magnetic cog wheel might be employed on a single car.

### VI. Eddy-Current Losses in the Halbach-Array Magnets

In the magnetic gear box, as the gears rotate each magnet block experiences, once per revolution, a pulse of magnetic field from the magnets of the Halbach array in the mating gear. This pulse of magnetic field will generate eddy currents in the magnet block, leading to energy losses and heating. Whether this is an important effect, or one that can be ignored depends on the rate of rotation of the gear, the conductivity of the magnetic material, and the environment (e.g., air at atmospheric pressure or vacuum) in which the gears rotate. Approximate calculations of the eddy-current losses have been made for the Example I case. These results, calculated for Neodymium-Iron-Boron magnets, will be summarized below. In this low-speed case the losses were only 2 or 3 percent of the power handled, and cooling by flowing air is sufficient. In cases involving high-speed operation, or in cases where some or all of the magnets operate in a vacuum, the substitution of bonded Nd—Fe—B magnets (Br=0.69 Tesla) or ferrite magnets (Br=0.39 Tesla), both of which have near-zero electrical conductivity, is indicated. This substitution would eliminate the problem of eddy-current losses at high speeds or for magnets operating in a vacuum, provided the support structure for the magnets is also made of low-conductivity material.

For Example I, in the large gear train suitable for wind-turbine applications, the rotation speeds are low so that the eddy-current losses are comparatively small, being about 375 watts for each gear-gear interface. In that system, which has a ring gear, four planetary gears, and a central gear, there are 8 gear-gear interfaces, for a total power loss of 6.0 kW, corresponding to a gear box efficiency (not counting the losses in the supporting mechanical bearings) of 99.4 percent. This level of heat loss could be easily handled by air flow through the system.

For Example III, where the rotation speeds are much higher, the eddy current losses with NdFeB magnets are higher, but still appear to be within tolerable limits for forced-air cooling. In this example the eddy-current loss in the inner gear is about 3.7 kW. The overall gear efficiency (ring gear plus inner gear) is then 97.5 percent. As noted above in this case, in order to reduce the cooling requirements it would be advantageous to substitute bonded NdFeB magnets, or ferrite magnets, for which the eddy-current losses would be negligible (but the throughput power rating using the same size gears would be lower).

### VI. Summary of Section I

Novel designs for mechanical gear boxes have been described, one in which the “gears” are composed of permanent-magnet Halbach arrays mounted on cylindrical surfaces at the ends of which are located conventional bearings. The periodic nature of the magnetic fields from the Halbach arrays creates a series of invisible “cogs” on the surface of these cylinders that interact with similar “cogs” on mating cylindrical Halbach arrays. This kind of gear box requires no inter-gear lubrication and involves no mechanical wear of the gears. It also provides a means for transmitting the gear forces through a dielectric barrier, for example between an evacuated chamber and a region at atmospheric pressure. Other examples of the use of these magnetic “cog wheels” are their use in transit systems as a means of extracting “housekeeping” power from the relative motion of a train car and the track, or in order to provide a means for driving the train car itself.

The calculations presented here demonstrate that the new system should be capable of handling, at high efficiency, power transfer rates that are comparable to those handled by very large conventional gear boxes such as those used in wind-turbine systems. The new systems can also be scaled down in size for use in a variety of industrial or other settings.

### Section II

This section describes an alternate geometrical configuration for the magnetic gear trains described above. In Section I, embodiments of the “gears” are composed of two or more elongated cylinders (fitted at each end with conventional bearing so as to allow rotation). On the outer periphery of these cylinders are mounted Halbach arrays that create azimuthally periodic magnetic fields. These magnetic fields give rise to attractive or repulsive forces between two adjacent “gears” (the elongated cylinders). These forces transmit the torque required for gear action.

The new configuration makes use of planar Halbach arrays mounted on the surfaces of discs that are in turn mounted on axels supported at their ends by conventional mechanical bearings. To increase the torque-handling ability of the gear system, several such discs can be mounted on a single shaft, with mating discs mounted on another shaft interleaved with these discs.

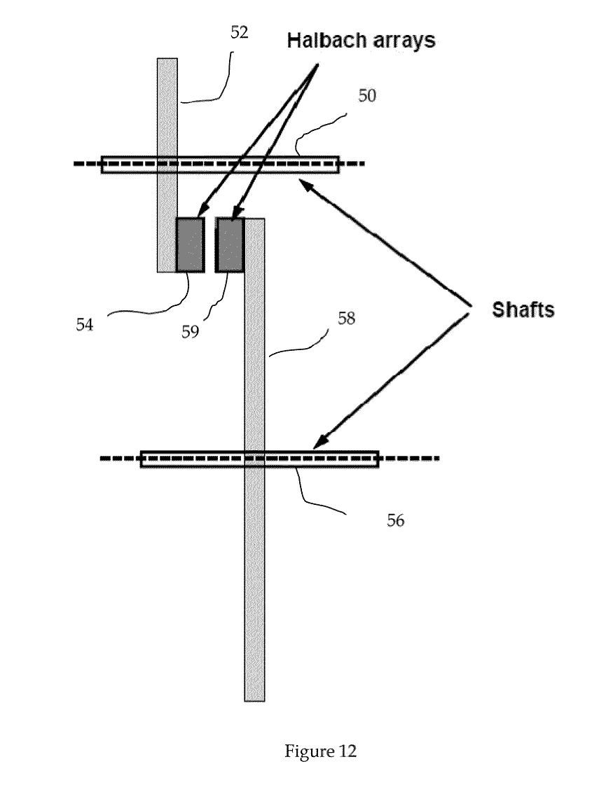

In the present case the forces between the disc-mounted Halbach arrays are axially directed. Rotation of a “primary gear” disc will therefore result in a torque being exerted on the adjacent “secondary gear” disc. The torque components that give rise to the total inter-gear torque will be greatest for the case where the two Halbach arrays are aligned parallel to each other, diminishing with azimuthal angle about this maximum point, i.e., as the alignment between the Halbach arrays deviates from being parallel with change in the relative azimuthal angle. The net torque that can be exerted per disc will than be given by averaging the torque components over the azimuthal deviation from the parallel orientation. An approximate evaluation of this average will be given below to illustrate the level of torque per mating disc surfaces that is obtainable. As noted above, the total torque can be increased by, (1) mounting Halbach arrays on both surfaces of the discs, and, (2) by mounting several discs on a single shaft. FIG. 12 illustrates the new configuration, for the case of the primary gear having twice the radius of the secondary gear. One gear includes a shaft 50 that upon rotation drives a disk 52 that has Halbach arrays 54 near its peripheral edge. The mating gear has a shaft 56 that drives a disk 58 that has Halbach arrays 59 near its peripheral edge.

### Section III

### Helical Gear Configuration of Halbach Array Gear Train

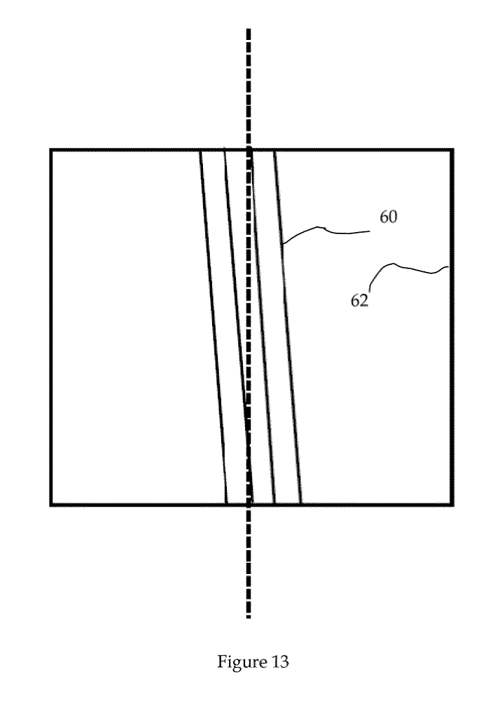

Prior-art magnetic gear systems, such as those of J. E. Rode (U.S. Pat. No. 5,569,967), have an intrinsic deficiency in terms of exhibiting substantial periodic variations of the inter-gear torque that they produce. These periodic variations arise from the marked changes in the inter-gear geometry that occur during rotation. Such changes are ameliorated in the Halbach array gear trains described above, but it would be advantages to be able to reduce these variations to a minimum. Such a reduction can be effected by using a drum-shaped gear on which the Halbach arrays are displaced azimuthally with respect to each other in moving down the drum. This displacement is shown schematically in FIG. 13 where the magnets 60 of the arrays are seen to be aligned helically so that a displacement (e.g., of order one-quarter wavelength of the array) occurs in moving from one end of the drum 62 to the other end. In this way a geometrical averaging is produced that will essentially cancel the otherwise-occurring azimuthal variation in torque between that gear and a similarly shaped gear that is being driven.

### Section IV

### Layered Halbach Arrays and Applications

### I. Introduction

Permanent-magnet Halbach arrays are employed in the Inductrack magnetic levitation system [1] and in motors and generators [2]. These applications have always employed in their various embodiments what is herein referred to as “single-layer” Halbach arrays. This section describes embodiments of a Halbach array configuration, one made up of two or more layers of Halbach arrays, the wavelengths and relative phases of which vary from layer to layer. The magnetic fields generated by each individual layer combine at the “working surface” (e.g., at the windings of a generator or motor) to produce a net magnetic field that can be, for example, higher in amplitude and more sharply peaked than that generated by a single-layer Halbach array with the same total weight of magnets. This higher amplitude of field can, for example, result in a decrease in the drive current required to achieve a given driving force from the LSM (Linear Synchronous Motor) drive of an Inductrack train car. Another application of the concept that takes advantage of its ability to produce highly peaked magnetic fields is its use to design high-power, high-frequency, electric generators. The output frequency of these generators, in the low radio-frequency range, is well suited for such uses as the induction heating of metals. Other examples of the uses of layered Halbach arrays are discussed in the sections to follow.

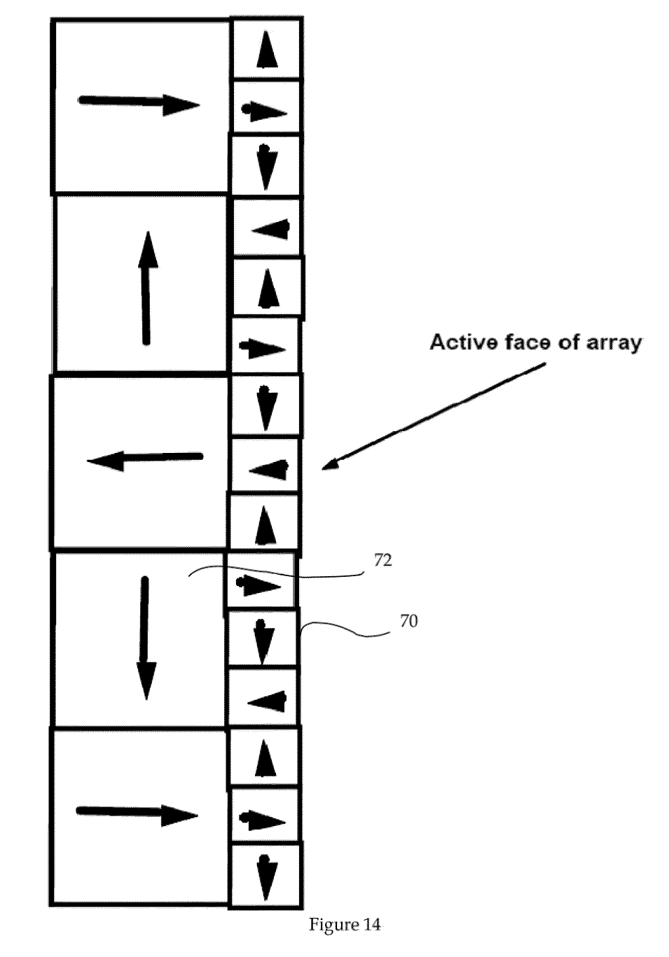

FIG. 14 is a schematic drawing of a layered Halbach array where the outer layer 70 (the one defining the “front surface” of the Halbach array) has a wavelength that is one-third of that of the main array 72 beneath it. In the case shown the phasing of the two arrays is such as to enhance the peak value of the field produced by the main (fundamental wavelength) Halbach array beneath it.

The drawing depicts a linear version of the layered Halbach array, appropriate for its use in an LSM. In other applications described below this array could also take a circular form, as it might be used in a generator/motor application.

### II. “Shimming” the Halbach Array Fields to Cancel High-Order Harmonics

An application of the concept would be its use in “shimming” the magnetic field produced by a lower order, e.g. an M=4 (four magnet bars per wavelength) Halbach array. The purpose of the shimming of such an array would be to improve its waveform, i.e., to reduce the level of higher order spatial harmonics of the magnetic field, so that the magnetic field at the working surface is nearly purely sinusoidal in nature. Among the situations where this technique could be valuable is, again, in a variable-speed LSM where proper operation of the drive control circuitry could require a near-sinusoidal spatial variation of the magnetic fields of the Halbach arrays.

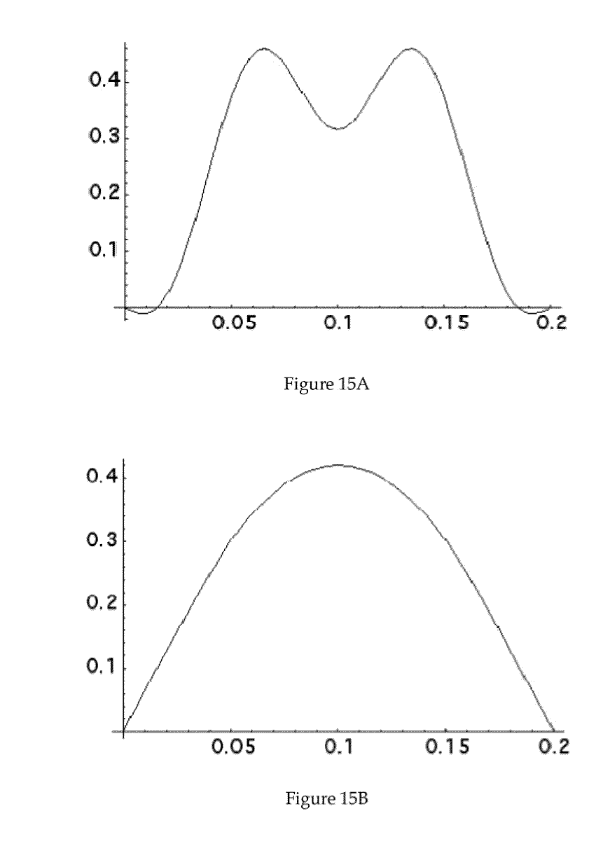

The field-shaping effect of the shimming technique just described is illustrated in FIGS. 15A and 15B, obtained by calculations performed with a 3-D Halbach array computer code. The left-hand figure shows the spatial waveform of the vertical field component (at a typical gap distance from the surface of the array) of a particular M=4 array, deviating from a sinusoidal shape as shown. As predicted by Halbach's theory of his array [3], at working distances from the front surface of an M=4 array the dominant spatial harmonic is the fifth harmonic, with a phasing such as to depress the peak value of the magnetic field, thus producing the double-humped shape shown in the figure. On the right hand side of the figure there is shown the spatial variation of the vertical component of the magnetic field (at the same gap distance) produced by a layered Halbach array in which an array with one-fifth the fundamental wavelength and 1/20^{th} the thickness of the main array is placed on the top of the main array. As can be seen from the figure the resultant waveform is accurately sinusoidal in form.

The 3-D Halbach-array computer code alluded to above shows that, because of the finite width of the M=4 Halbach array that was assumed in the calculation, the horizontal field component of the array has a slightly different magnitude of fifth harmonic than that of the vertical component. There will therefore be a correspondingly small deviation of the resultant horizontal field component of the shimmed array from a pure sinusoidal form, a deviation that would become negligibly small for arrays that are wide compared to the gap distance.

### III. Analogy with Electronic Circuits; Formation of Peaked Waveforms

The basic concept involved here, the superposition of magnetic fields of different periodicity to form a particular desired field configuration, is analogous to the technique used in electronic systems, where fundamental-frequency waves and their harmonics are combined in the circuit in order to generate a desired wave shape, e.g., an approximation to a periodic square-wave pulse.

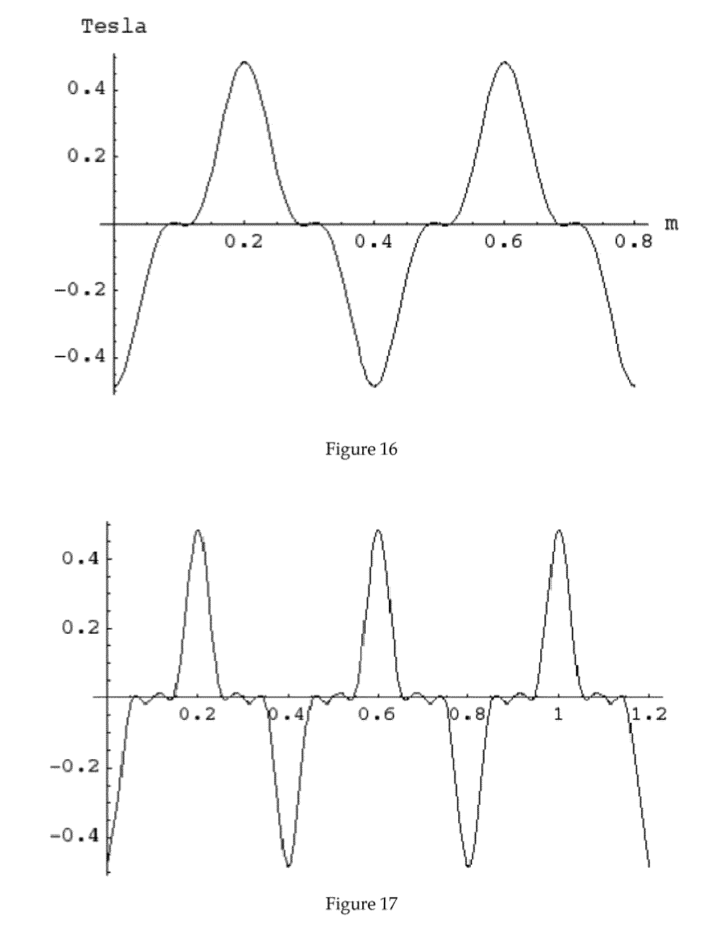

An example of using a layered Halbach array for producing a peaked wave shape has the following parameters: The total thickness of the two-layer array (shown schematically in FIG. 14) was 50 mm. In this example case, the outer, third-harmonic, layer of magnets had a thickness of 5.6 mm, i.e., one-ninth of the 44.4 mm thickness of the main, underlying, Halbach array. The resultant calculated field is shown in FIG. 16. As can be seen the field is markedly peaked. When compared with the sinusoidal-shaped field calculated for a single Halbach array with the same total thickness, the two-layer Halbach array field has a peak amplitude that is a factor of 1.16 higher than that of the same-thickness single-layer Halbach array. This result means that the peak current required to produce a given drive force can be reduced by a corresponding factor, This situation would apply, for example, in an LSM drive employing short current pulses in its stator windings, timed to coincide with the peak field, to produce the accelerating force. It follows that the resistive losses in the LSM drive windings (reduced by the square of the above factor) would be only 75 percent of the resistive losses of a pulsed LSM operated with a single-layer Halbach array of the same thickness (50 mm) as the dual-layer one of the example. The example given illustrates the kind of improvement in efficiency of pulsed LSM systems that are possible with the new configuration. Similar calculations have not as yet been performed for a conventional multi-phase LSM drive, but it can be expected that efficiency gains will be found, particularly for systems with a number of phases greater than three.

By adding a third, fifth harmonic, layer on top of the third-harmonic layer an even more peaked spatial waveform can be generated, as shown in FIG. 17. In this example the peak field is 1.35 times as high as the peak field that would be produced by a single-layer Halbach array with the same total thickness as that of the three-layer one, so that the resistive power dissipated in the windings of a pulsed LSM drive would be only 55 percent of the resistive losses of a drive producing the same thrust but employing a single-layer Halbach array of the same total thickness.

### IV. Generator Applications of Layered Halbach Arrays

Another, distinctly different, application of the concept would be its use in a generator that employed Halbach arrays mounted on its rotor to produce its magnetic fields. By shaping the magnetic fields from the layered arrays to produce, for example, highly peaked waveforms, the output of the generator could take the form of a series of high-power pulses. As will be discussed, these pulses could be combined to produce high power at radio frequencies. One possible use of such a generator would be, for example, its use for the induction heating of metals, at very high power levels and at a cost per kilowatt of output power that could be much less than that of conventional radio-frequency power sources.

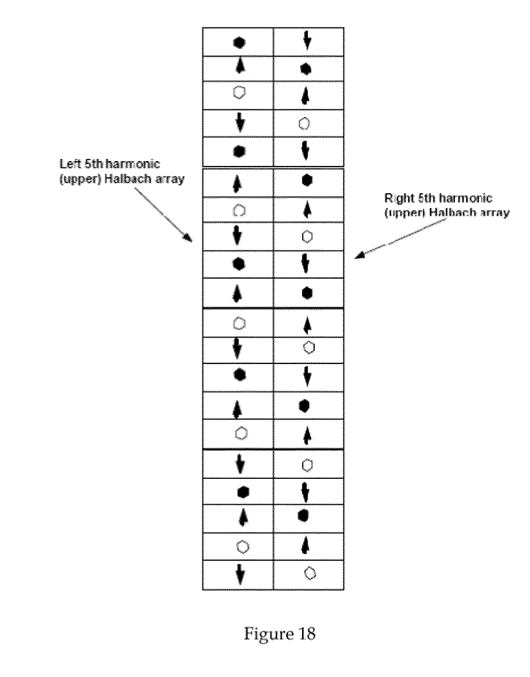

An example of this use of layered Halbach arrays in a generator in order to produce high powers at radio frequencies is the following: In the generator, the field magnet array would be made up of the following elements, shown schematically in FIG. 18. As shown there are two side-by side arrays. Each is a three-layer array composed of the following elements: The innermost layer is an M=4 or M=8 Halbach array having, for example, a thickness of order one-quarter of the wavelength of the array. On top of each inner array there is located an additional double-layer array, with a total thickness that is much smaller than that of the innermost array. The wavelength of the inner one of these two added outer arrays is one-third that of the primary array, and the wavelength of the outer one of the added arrays is one-fifth of that of the main array beneath them. The peaks of the added arrays are phased with respect to the primary array so that they reinforce each other at positions one-half wavelength of the inner array apart, while they tend to cancel at intermediate positions, as a result producing a highly peaked waveform such as that shown in FIG. 17.

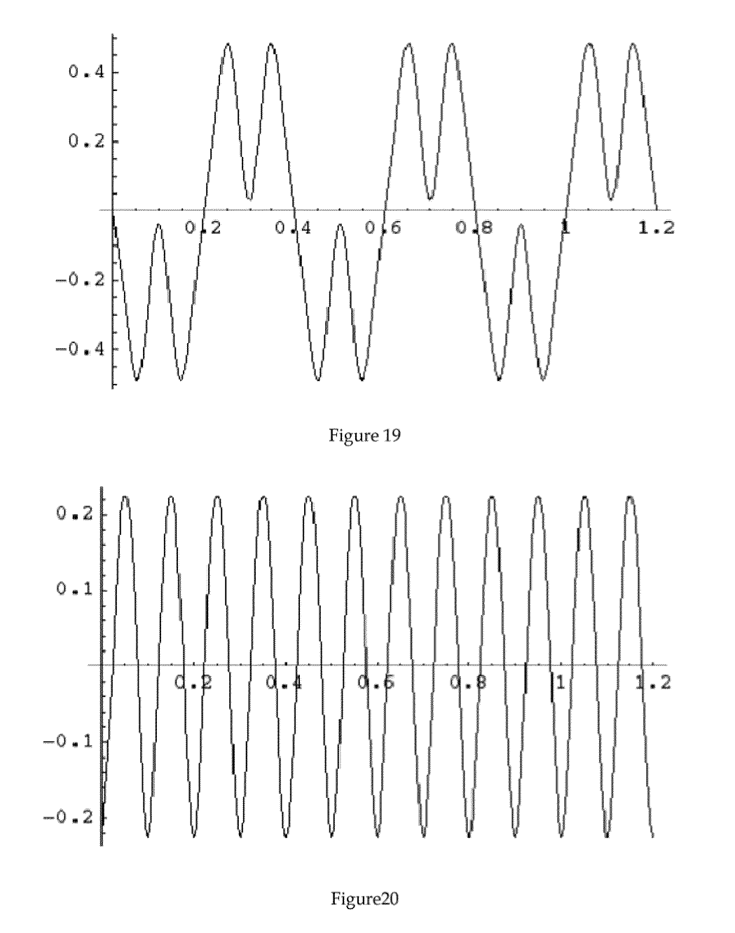

To produce the desired end result the side-by-side three-layer arrays are displaced in phase with respect to each other by one-quarter of the primary wavelength. For this case an axially oriented conductor in the stator spanning the width of the two side-by side arrays would be exposed to a time-varying magnetic field that would consist of two peaked waveforms such as the one shown in FIG. 17, phase-shifted with respect to each other. The output voltage waveform (proportional to the time-derivative of the magnetic waveform) would then have the form shown in FIG. 18. Finally, this output would be full-wave rectified by a solid-state bridge rectifier, and its direct-current component removed by a coupling condenser. The resultant output waveform, shown in FIG. 19, is seen to have a nearly pure sinusoidal waveform, but at a frequency that is four times that associated with the primary wavelength of the Halbach arrays.

The output power can be estimated from the theory of the Halbach-array generator [4]. An example case has the parameters given in Table I below.

TABLE I

| | | |
|---|---|---|
| Generator rotation frequency | 3600 | RPM |
| Stator winding radius | 0.5 | meters |
| Stator winding length | 0.5 | meters |
| Halbach-array magnetic field at stator | 0.3 | Tesla |
| windings | | |
| Wavelength of main (inner) Halbach | 0.1 | meters |
| array | | |
| Output frequency | 7.5 | kHz |
| Output power | 5 | Megawatts |

It is estimated that the cost of this generator would be much less than the cost of a conventional radio frequency source generating the same power at the same frequency. As noted, one possible use of such a generator would be as an rf power source for factory-scale induction heating of metals.

### V. Conclusion

Applications of the layered Halbach array concept have been discussed, ranging from its use in various ways in designing LSM drive motors for magnetically levitated trains to its employment in special-purpose electric generators. The general principle involved, the superposition of harmonics of a fundamental wave to create special waveforms, has long been employed in electronic circuits. The layered Halbach array concept allows the same type of waveform synthesis to be applied to the spatial waveform of magnetic fields produced by arrays of permanent magnets.

U.S. Provisional No. 61/144,673, titled “Gear Trains Employing Magnetic Coupling,” filed Jan. 14, 2009 is incorporated herein by reference.

### REFERENCES INCORPORATED HEREIN BY REFERENCE

[1] U.S. Pat. No. 5,722,326, “Magnetic Levitation System for Moving Objects.”
[2} U.S. Pat. No. 5,705,902, “Halbach Array Generator/Motor.”
[3] K. Halbach, “Application of permanent magnets in accelerators and electron storage rings, “Journal of Applied Physics,” vol. 57, p. 3605, 1985.
[4] U.S. Pat. No. 6,858,962 B2. “Halbach Array Generator/Motor Having An Automatically Regulated Output Voltage and Mechanical Power Output.”

The foregoing descriptions of the invention have been presented for purposes of illustration and description and are not intended to be exhaustive or to limit the invention to the precise forms disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. An apparatus, comprising:
at least one movable member;
a secondary member; and
at least one first Halbach array mounted on said at least one movable member, wherein said at least one movable member and said a secondary member are in operable proximity such that upon movement of said at least one movable member, said at least one first Halbach array creates azimuthally periodic magnetic fields that transmit force between said at least one movable member and said secondary member.

2. The apparatus of claim 1, wherein said at least one movable member comprises a first circular dimension.

3. The apparatus of claim 2, wherein said secondary member comprises at least one second movable member having a second circular dimension and wherein said secondary member further comprises at least one second Halbach array mounted on said secondary member.

4. The apparatus of claim 3, wherein said at least one movable member and said at least one second movable member are rotatable, wherein said force comprises torque.

5. The apparatus of claim 4, wherein said at least one movable member comprises a first elongated cylinder with bearings fitted at each end and wherein said secondary member comprises a second elongated cylinder with bearings fitted at each end, wherein said at least one first Halbach array is fixedly attached to said first elongated cylinder and wherein said at least one second Halbach array is fixedly attached to said second elongated cylinder.

6. The apparatus of claim 3, wherein movement of one of said at least one first Halbach array or said at least one second Halbach array causes said force to vary in a periodic manner.

7. The apparatus of claim 6, wherein said force comprises a perpendicular force with respect to the face of said at least one first Halbach array or said at least one second Halbach array and wherein said at least one first Halbach array and said at least one second Halbach array comprises permanent magnet orientations such that said force will be attractive when the perpendicular components of said at least one first Halbach array and said at least one second Halbach array are additive, and repulsive when these components are opposite in direction.

8. The apparatus of claim 4, further comprising a brake to attenuate relative movement between said at least one first Halbach array and said at least one second Halbach array.

9. The apparatus of claim 8, wherein said brake comprises a conducting metallic sheet and means for inserting said sheet between said at least one first Halbach array and said at least one second Halbach array.

10. The apparatus of claim 1, wherein said at least one movable member is a disc having a central axle, wherein said secondary member is movable and is a second disc comprising a second central axle, wherein said at least one second Halbach array is mounted on said second disc, wherein said first axle comprises a first set of bearings allowing rotation of said first axle, wherein said second axle comprises a second set of bearings allowing rotation of said second axle, wherein said first axle and said second axle are substantially parallel, wherein said first disc and said second disc are substantially parallel, wherein said at least one first Halbach array and said at least one second Halbach array are substantially planar and are substantially parallel to one another.

11. The apparatus of claim 10, wherein said force is axially exerted between said at least one first Halbach array and said at least one second Halbach array.

12. The apparatus of claim 3, wherein said first movable member is configured in a drum shape and wherein said at least one first Halbach array is configured on said drum to be displaced azimuthally and, helically with respect to said second movable member.

13. The apparatus of claim 3, wherein said second movable member is configured in a drum shape and wherein said at least one second Halbach array is configured on said drum to be displaced azimuthally and helically with respect to said first movable member.

14. The apparatus of claim 5, wherein said first movable member and said second movable member are respectively aligned helically so that a displacement occurring moving from one end of at least one of (i) said first elongated cylinder to the other end of said first elongated cylinder and (ii) said second elongated cylinder to the other end of said second elongated cylinder will produce geometrical averaging of said force that will substantially cancel azimuthal variations in torque between said first movable member and said second movable member.

15. The apparatus of claim 3, wherein at least one of said at least one first Halbach array and said second set of Halbach arrays comprise two or more layers of Halbach arrays, the wavelengths and relative phases of which vary from layer to layer such that magnetic fields generated by each individual layer combine to produce a net magnetic field that is higher in amplitude and more sharply peaked than that generated by a single-layer Halbach array with the same total weight of magnets.

16. The apparatus of claim 3, wherein at least one of (i) said at least one first Halbach array and (ii) said at least one second Halbach array comprises a plurality of Halbach arrays.

17. The apparatus of claim 1, wherein said secondary member comprises a fixed iron rail, wherein said at least one first Halbach array is configured to transmit torque upon movement of said first movable element to said iron rail by magnetic force, wherein said torque is transferred with no physical contact occurring between said first movable element and said iron rail.

18. The apparatus of claim 3, wherein said at least one first movable member and said at least one second movable member are configured in a ring and planetary gear assembly.

19. The apparatus of claim 18, wherein said ring and planetary gear assembly comprises a ring gear, at least one off-center gear and a single center gear.

20. A method, comprising:
moving at least one movable member relative to a secondary member, wherein at least one first Halbach array is mounted on said at least one movable member, wherein said at least one movable member and said a secondary member are in operable proximity such that upon movement of said at least one movable member, said at least one first Halbach array creates azimuthally periodic magnetic fields that transmit force between said at least one movable member and said secondary member.

21. The method of claim 20, wherein said at least one movable member comprises a first circular dimension.

22. The method of claim 21, wherein said secondary member comprises at least one second movable member having a second circular dimension and wherein said secondary member further comprises at least one second Halbach array mounted on said secondary member.

23. The method of claim 22, wherein said at least one movable member and said at least one second movable member are rotatable, wherein said force comprises torque.

24. The method of claim 23, wherein said at least one movable member comprises a first elongated cylinder with bearings fitted at each end and wherein said secondary member comprises a second elongated cylinder with bearings fitted at each end, wherein said at least one first Halbach array is fixedly attached to said first elongated cylinder and wherein said at least one second Halbach array is fixedly attached to said second elongated cylinder.

25. The method of claim 22, wherein movement of one of said at least one first Halbach array or said at least one second Halbach array causes said force to vary in a periodic manner.

26. The method of claim 25, wherein said force comprises a perpendicular force with respect to the face of said at least one first Halbach array or said at least one second Halbach array and wherein said at least one first Halbach array and said at least one second Halbach array comprises permanent magnet orientations such that said force will be attractive when the perpendicular components of said at least one first Halbach array and said at least one second Halbach array are additive, and repulsive when these components are opposite in direction.

27. The method of claim 23, further comprising a brake to attenuate relative movement between said at least one first Halbach array and said at least one second Halbach array.

28. The method of claim 27, wherein said brake comprises a conducting metallic sheet and means for inserting said sheet between said at least one first Halbach array and said at least one second Halbach array.

29. The method of claim 20, wherein said at least one movable member is a disc having a central axle, wherein said secondary member is movable and is a second disc comprising a second central axle, wherein said at least one second Halbach array is mounted on said second disc, wherein said first axle comprises a first set of bearings allowing rotation of said first axle, wherein said second axle comprises a second set of bearings allowing rotation of said second axle, wherein said first axle and said second axle are substantially parallel, wherein said first disc and said second disc are substantially parallel, wherein said at least one first Halbach array and said at least one second Halbach array are substantially planar and are substantially parallel to one another.

30. The method of claim 29, wherein said force is axially exerted between said at least one first Halbach array and said at least one second Halbach array.

31. The method of claim 24, wherein said first movable member and said second movable member are respectively aligned helically so that a displacement occurring moving from one end of at least one of (i) said first elongated cylinder to the other end of said first elongated cylinder and (ii) said second elongated cylinder to the other end of said second elongated cylinder will produce geometrical averaging of said force that will substantially cancel azimuthal variations in torque between said first movable member and said second movable member.

32. The method of claim 21, wherein at least one of said at least one first Halbach array and said second set of Halbach arrays comprise two or more layers of Halbach arrays, the wavelengths and relative phases of which vary from layer to layer such that magnetic fields generated by each individual layer combine to produce a net magnetic field that is higher in amplitude and more sharply peaked than that generated by a single-layer Halbach array with the same total weight of magnets.
